(19) United States
(12) Patent Application Publication
(10) Pub. No.: US 2005/0282122 A1
(43) Pub. Date: Dec. 22, 2005

(54) Handwriting tool

(76) Inventor: Lisa Crawford, Kansas City, MO (US)

Correspondence Address: SHOOK, HARDY & BACON LLP, 2555 GRAND BLVD, KANSAS CITY,, MO, 64108, US

(21) Appl. No.: 10/871,307

(22) Filed: Jun. 18, 2004

(51) Int. Cl. G09B 19/00; G09B 1/00

(52) U.S. Cl. 434/159; 434/155

(57) ABSTRACT

A progressive handwriting tool utilizes one of (a) color contrast within a writing segment, or (b) a grid of sloped lines, to properly guide a student in writing print and/or cursive letters in a proper style and form. In one aspect, a print writing tool includes a writing medium, such as a sheet of paper or an electronic input capturing device, where a plurality of writing segments comprised of first and second rectangular regions are formed thereon. The rectangular regions extend horizontally in a stacked arrangement, and have contrasting colors to clearly differentiate between upper and lower areas where uppercase and lowercase letters are to be written. In another aspect, a cursive writing tool includes a writing medium onto which is formed a set of parallel horizontal lines and a set of diagonal lines of constant slope. The horizontal and diagonal lines intersect to form an array of writing boxes, with each box configured to have one letter of a cursive word written therein. The progressive handwriting tool may be accompanied by writing programs or instructions on how to practice handwriting skills with the tool, such that the programs and tool together form an instructional writing kit.

### CROSS-REFERENCE TO RELATED APPLICATIONS

None

### STATEMENT REGARDING FEDERALLY SPONSORED RESEARCH OR DEVELOPMENT

Not Applicable.

### BACKGROUND OF THE INVENTION

Instructional writing paper has been utilized for many years to improve the handwriting skills of children. A typical arrangement includes a series of parallel, horizontal solid and dashed guide lines formed of a sheet of paper, where one dashed line is equally spaced between a pair of solid lines to form one writing segment in which handwriting may be practiced. The division created by the dashed line forms upper and lower areas of the writing segment, where the main body of lowercase letters is to be formed in the lower areas (i.e., between the dashed line and the lower solid line) and uppercase or capital letters are to be formed in both of the upper and lower areas (i.e., above and below the dashed line between the pair of solid lines). The writing segment is typically repeated in a pattern down the writing paper to form a series of writing segments, with open areas spacing the writing segments from one another. The ascending portions of the lowercase letters—such as, for example, with the letter “d”—will extend into the upper area of the writing segments, and the descending portions of the lowercase letters—such as, for example, with the letter “p”—will extend into the open area between the writing segments and below the lower area of the segments.

The aforementioned teaching instrument suffers from the drawback of, for many children, being an inadequate visual indicator of where writing should take place. More specifically, children often lose track of the dashed line creating the writing segment division because there is not enough visual contrast to capture the writer's attention as they are focusing specifically on the letter as it is being formed by the writing instrument they are holding. In addition, some writing paper is gray in color with blue and red guide lines, which has been found to be a poor visual indicator for many children. The use of guide lines alone in writing tools can also be confusing for some children in that they don't always understand the concepts of above, below and underneath when explaining the location relative to the lines where letters are supposed to be written.

Moreover, the need for effective handwriting teaching tools has never been greater given the emphasis on written language in the Federal “No Child Left Behind” Act (referred to herein as “the Act” or “No Child Left Behind”). The Act requires students (i.e., children) to have a basic understanding of the English language in the context of written words by the 3^{rd} grade. If a tool could simplify the teaching and learning of handwriting, students could more quickly master letter formation, spacing and legibility, and therefore focus on the content of the written language at a much sooner pace, decreasing learning difficulty.

### BRIEF SUMMARY OF THE INVENTION

The present invention overcomes these deficiencies by providing a progressive handwriting tool that seeks to improve a student's handwriting up to at least a baseline standard. This standard may be achieved in print writing when the main body of lowercase letters are formed in a designated lower area (and the remaining parts of the letter are in proper form), and may be achieved in cursive writing when letters are at a slope that is conducive to a student observing a proper cursive writing style, as well as proper sizing and spacing.

In one aspect, the progressive handwriting tool is in the form of a print writing tool utilizing color contrast within a writing segment to properly guide a student in writing in a proper style and form. The print writing tool includes a writing medium, such as a sheet of paper or an electronic input capturing device, where a plurality of writing segments comprised of first and second rectangular regions are formed thereon. The rectangular regions extend horizontally in a stacked arrangement, and have contrasting colors to clearly differentiate between upper and lower areas where uppercase and lowercase letters are to be written. Optionally, a dashed or other thin line may be formed between the rectangular regions. In this way, the student can easily perceive the boundaries within which portions of uppercase and lowercase letters are to be formed even while the student is concentrating on the letter currently being written.

In another aspect, the progressive handwriting tool is in the form of a cursive writing tool for to improving a student's cursive writing structure. This cursive writing tool includes a writing medium onto which is formed a set of parallel horizontal lines and a set of diagonal lines of constant slope. The horizontal and diagonal lines intersect to form an array of writing boxes, with each box configured to have one letter of a cursive word written therein. The diagonal lines are set at a slope that is conducive to a student observing a proper cursive writing style and form as they are writing in the boxes. In an additional use, the cursive writing tool may have diagonal lines alone to take the form of a writing guide; such a guide may be placed beneath a horizontally lined sheet of writing paper having properties that enable the diagonal lines of the guide to be at least partially seen through the lined writing paper, the diagonal lines of the guide and the horizontal lines of the writing paper together forming writing boxes. Thus, the student may use the guide to write in cursive on the lined writing paper.

The progressive handwriting tool of the present invention may also be accompanied by writing programs, for example in an instructional writing kit. In this way, a comprehensive solution for improving handwriting skills may be provided.

### BRIEF DESCRIPTION OF THE SEVERAL VIEWS OF THE DRAWING

FIG. 1 illustrates one embodiment of a handwriting tool of the present invention used for teaching cursive writing techniques;

FIG. 2 is a close-up view of the handwriting tool of FIG. 1 showing the array of writing boxes;

FIG. 3 is a perspective view showing the handwriting tool of FIG. 1 positioned behind a sheet of writing paper for use as a writing guide;

FIG. 4 is a close-up view illustrating another embodiment of the handwriting tool of the present invention that may be used as a writing guide for cursive writing; and

FIG. 5 shows the handwriting tool of FIG. 4 positioned behind a sheet of horizontally lined writing paper for use as a writing guide;

FIG. 6 shows another embodiment of the handwriting tool of the present invention used for teaching print writing techniques; and

FIG. 7 is a close-up view of the handwriting tool of FIG. 6 in use with a student writing print lowercase letters.

### DETAILED DESCRIPTION OF THE INVENTION

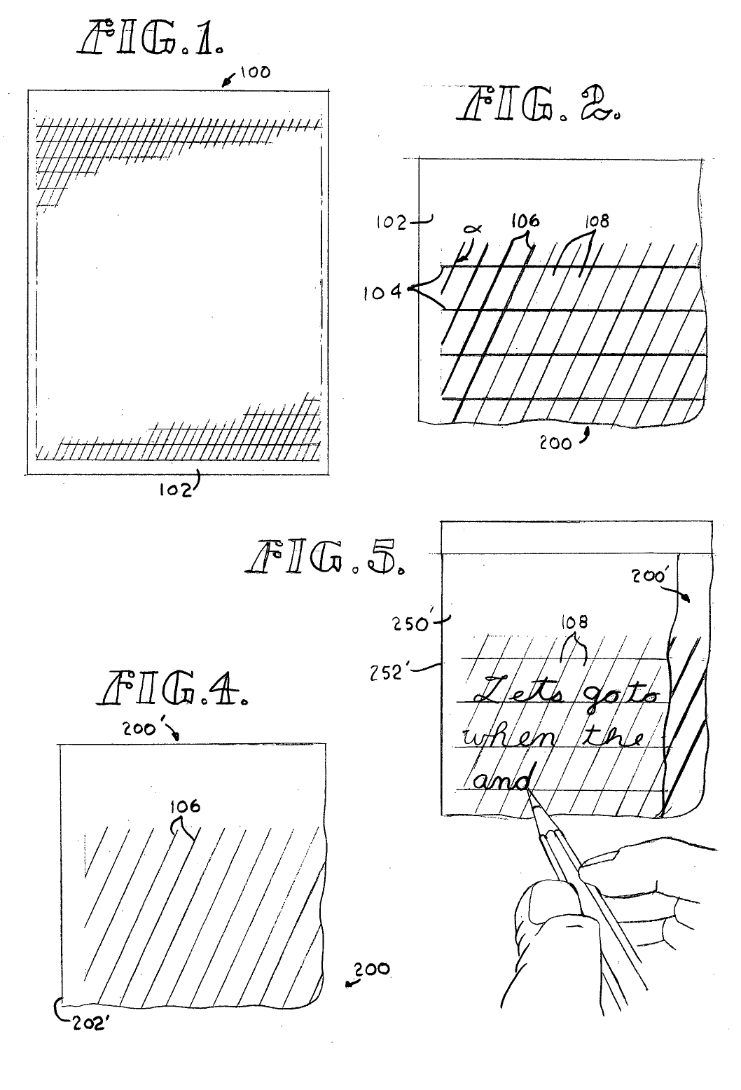

With specific reference to the drawing and the several views thereof, where like numerals indicate like elements throughout the several views, there is shown various embodiments of a progressive handwriting tool of the present invention. This tool make take the form of a print writing tool or a cursive writing tool, each being useful in improving and practicing the style and form of a student's handwriting, whether print or cursive. More specifically, a cursive writing tool 100 shown in FIGS. 1 and 2, and another embodiment of a cursive writing tool in the form of writing guides 200, 200′ shown in FIGS. 3-5, may be used to teach a student in cursive handwriting techniques. Likewise, yet another embodiment of the progressive handwriting tool, specifically in the form of a print writing tool 300 shown in FIGS. 6 and 7, may be used to teach a student proper handwriting techniques for uppercase and lowercase print writing. While the various embodiments of the progressive handwriting tool of the present invention are frequently described as being a training instrument for children, the present invention is particularly well suited for individuals (i.e., students) of any age or schooling to work on their handwriting skills.

With specific reference to FIGS. 1 and 2, the cursive writing tool 100 includes a writing medium 102 on which a set of parallel horizontal lines 104 and a set of diagonal lines 106 of constant slope are formed. The intersecting nature of the horizontal lines 104 and diagonal lines 106 form an array of writing boxes 108. Preferably, both the horizontal lines 104 and the diagonal lines 106 are equally spaced across the writing medium 102 such that the writing boxes are of equal size and are each formed in the shape of a parallelogram.

The writing medium 102 may be a traditional medium on which writing is conducted (e.g., a sheet of paper with a surface accepting ink or pencil lead markings, or a blackboard or other board formed of a material that accepts chalk markings) or may be an electronic medium such a display screen serving as an electronic input capturing device controlled by a computer processor (e.g., a personal digital assistant) that registers “touches” made to the screen by a stylus or other instrument and generates representative markings for display. In the case of an electronic medium, the array of writing boxes are displayed on the screen as directed by the computer processor.

The diagonal lines 106 ensure that the student is properly guided to cursively write in the proper style (i.e., with proper letter formation, spacing and legibility) in their ascending and descending writing motions in cursive letter formation as they are writing from left to right across the writing medium 102. The particular slope or range of slope for the diagonal lines 106—measured positively with respect to the horizontal lines 104 to form an angle a therebetween—may vary depending on a student's particular style and comfort in hand or paper positioning, or according to the instructor's desired methods of teaching cursive handwriting. As a general rule, the slope measured by the angle α is typically greater than 45 degrees and less than 90 degrees. One exemplary range for angle α that has been found to be particularly useful is between about 60 to about 85 degrees; however, those of skill in the art appreciate that angles outside of this range may be employed based for the reasons described herein.

The height and width of the writing boxes 108, dictated by the spacing between the horizontal lines 104 and the diagonal lines 106, respectively, is usually set to be larger for younger students that are first learning how to write cursively, and smaller as students progress in their cursive writing abilities and desire to write in the size of typical horizontally lined paper that is generally universally accepted. The writing box 108 size (i.e., the width, height, or both) is also designed to force the student to write only the body of one letter per writing box 108 as the student is writing horizontally across the writing medium 102, as seen in FIG. 5. Although certain portions of leading and trailing markings, or descending portions, of the letters formed may extending outside of an individual writing box 108, these portions are typically small enough that they do not interfere with the formation of letters in the adjacent writing boxes.

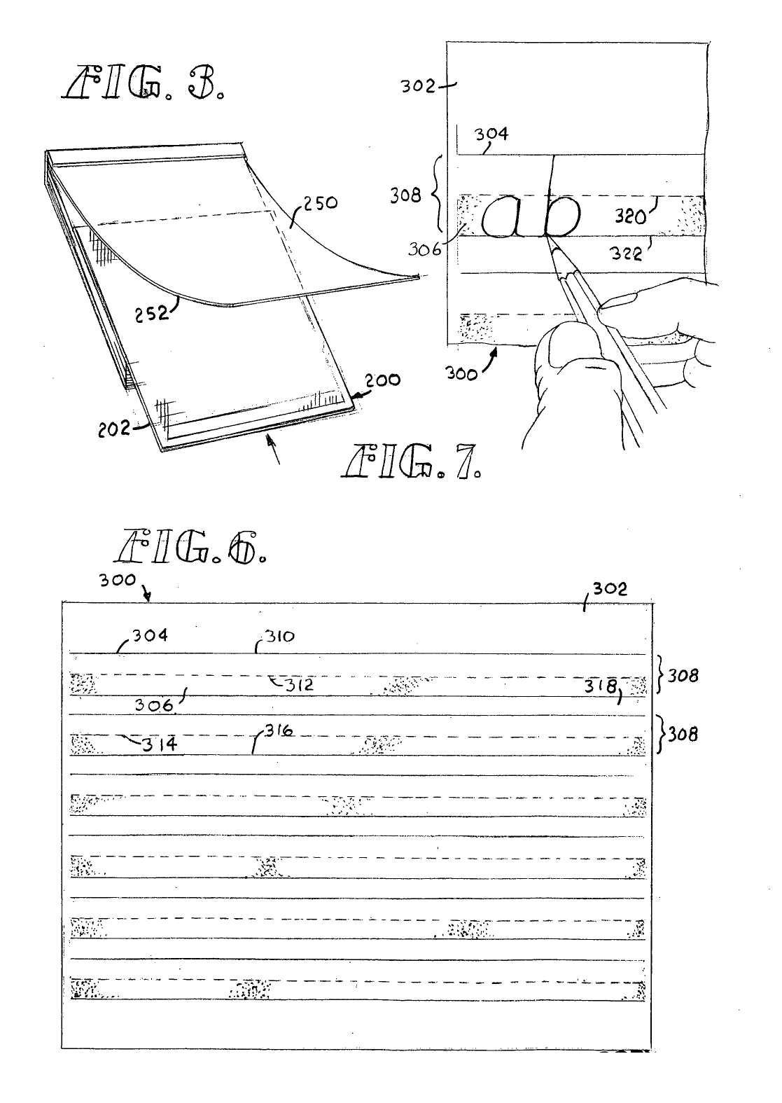

The writing medium 102 may be written on directly, or it may serve as writing guide 200 as shown in FIGS. 3-5. The writing guide 200, in the embodiment shown in FIG. 3, takes the form of the cursive writing tool 100 of FIGS. 1 and 2 positioned behind a generally unmarked sheet of writing paper 250 that can at least be partially seen through, such that the writing boxes 108 are visible therethrough and serve as guiding markings. More preferably, the another embodiment of the writing guide 200′, shown in FIG. 4, provides the set of diagonal lines 106 without the corresponding horizontal lines 104 necessary to form the writing boxes 108 on the guide. Instead, the writing guide 200′ is configured to be positioned behind standard writing paper, such as writing paper 250′ having horizontal lines, enabling the diagonal lines 106 to be visible therethrough and appear to intersect with the horizontal lines of the writing paper to form the writing boxes 108 serving as guide markings, as can be seen in FIG. 5. With both embodiments of the writing guide 200, 200′, at least one perimeter edge 202, 202′ of the guide is preferably lined up with a corresponding perimeter edge 252, 252′ of the writing paper as the guide is placed beneath the paper. This ensures that the slope of the diagonal lines 106 is correct for teaching proper cursive writing techniques. Also, the writing guide 200, 200′ may be laminated for increased durability.

The print writing tool 300 utilizes a writing medium 302 similar to the writing medium 102 of the cursive writing tool 100 of FIGS. 1 and 2 in the sense that such a medium 302 may be a traditional writing medium or may be an electronic medium as previously described herein. The writing medium 302 has formed thereon a first rectangular region 304 and a second rectangular region 306, at least one of which is shaded in a unique color to create a visual contrast between the two regions. The first rectangular region 304 and the second rectangular region 306 combine to form a writing section 308 extending horizontally across the writing medium 302, and a plurality of writing sections 308 may be formed on the medium 302, as shown in FIG. 6. The first rectangular region 304 serves as an upper area where ascending portions of lowercase letters (e.g., the upper portion of the letter “b” shown in FIG. 7) and the upper half of the body of uppercase letters are to be written, and the second rectangular region 306 serves as a lower area where the main body of lowercase letters (e.g., the letter “a” shown in FIG. 7) and the lower half of the body of uppercase letters are to be written. In one preferred arrangement shown in FIG. 7, the second rectangular region 306 is shaded or colored (e.g., a yellow color) and the first rectangular region 304 is not shaded or colored, and possesses the base color of the writing medium 302 (e.g., white or cream colored paper). However, both of the first and second rectangular regions 304, 306 may be colored if desired, or the coloring of the regions 304, 306 may be switched.

The first rectangular region 304 has a top edge 310 and a bottom edge 312, and the second rectangular region 306 has a top edge 314 coterminous with the bottom edge 312 of the first rectangular region 304 and a bottom edge 316. The coterminous first rectangular region bottom edge 312 and second rectangular region top edge 314 may be formed by a dashed line 320 to further differentiate between the regions 304, 306. Preferably, a standoff region 318 is positioned between adjacent writing sections 308 to vertically space the writing sections 308 from one another and provide an area where the descending portions of lowercase letters may be written. Alternatively, the standoff region 318 may be omitted and the second rectangular region bottom edge 316 of one writing section 308 may be coterminous with a first rectangular region top edge 310 of a writing section 308 immediately therebelow.

The aforementioned arrangement for the writing section 308 provides the student with a strong visual indicator of where the bodies of written letters are to be positioned—and especially, the body of lowercase letters—when proper handwriting techniques are being observed. The color contrast between the first and second rectangular regions 304, 306 alerts the writer to the boundaries they are to observe in letter formation, and is more easily perceptible to the student than the use of boundary or guide lines alone.

Also preferably, if one of the first or second rectangular regions 304, 306 is the same color as the writing medium 302 base color (i.e., the color of the paper), then a horizontal line 322 extending across the writing medium 302 and coterminous with one edge of the respective rectangular region is provided and serves as a guide line for proper letter formation.

For example, if the first rectangular region 304 is the same color as the base color, then the horizontal line 320 is coterminous with the top edge 310 of the region 304. One advantage to having one of the first or second rectangular regions 304, 306 be a color that is the same as the base color is that only one of the regions 304, 306 must be colored on the writing medium 302; the writing medium 302 itself provides the color to the region that is the same as the base color, for example, white. Therefore, it is easier to manufacture the print writing tool 300 when color is applied to the writing medium 302 for only one of the rectangular regions, 304 or 306.

Although the print writing tool 300 is shown in use in FIGS. 6 and 7 with “wide-spaced” paper primarily used as a handwriting teaching tool for students through the first grade, the concept of rectangular colored regions 304, 306 may be implemented with traditional notebook paper having a more narrow writing section height to transition students into writing properly using such notebook paper.

As can be seen, the various embodiments of the progressive handwriting tool of the present invention enable the student to improve their handwriting techniques for both print and cursive handwriting. Since certain changes may be made in the above invention without departing from the scope hereof, it is intended that all matter contained in the above description or shown in the accompanying drawing be interpreted as illustrative and not in a limiting sense. It is also to be understood that the following claims are to cover certain generic and specific features described herein.

1. A handwriting tool, comprising:
a writing medium;
a set of parallel horizontal lines formed on the writing medium;
a set of diagonal lines of constant slope formed on the writing medium and intersecting with the set of horizontal lines to form an array of writing boxes on the writing medium;

2. The handwriting tool of claim 1, wherein the diagonal lines are equally spaced across the writing medium.

3. The handwriting tool of claim 1, wherein the horizontal lines are equally spaced across the writing medium.

4. The handwriting tool of claim 1, wherein the writing medium is a sheet of paper.

5. The handwriting tool of claim 1, wherein the writing medium is an electronic input capturing device.

6. A method of instructing a person on how to write cursive letters, comprising:
providing a handwriting tool including,
a writing medium having formed thereon a set of parallel horizontal lines and a set of diagonal lines of constant slope intersecting with the set of horizontal lines to form an array of writing boxes;
providing instruction to cursively writing on at least a portion of the writing medium such that each box of the array of boxes contains substantially only one letter.

7. The method of claim 6, wherein the writing medium is a sheet of paper.

8. The method of claim 6, wherein the writing medium is an electronic input capturing device.

9. A method of writing cursive letters on a handwriting tool, the tool including a writing medium having formed thereon a set of parallel horizontal lines and a set of diagonal lines of constant slope intersecting with the set of horizontal lines to form an array of writing boxes, the method comprising:
cursively writing on at least a portion of the writing medium such that each box of the array of boxes contains substantially only one letter.

10. A method of instructing a person on how to write cursive letters, comprising:
providing a handwriting tool comprising a writing guide in the form of a sheet having formed thereon a set of diagonal lines of constant slope;
providing instruction to place the writing guide beneath a sheet of horizontally-lined writing paper, the writing guide positioned such that the diagonal lines are seen through the sheet of writing paper to intersect with the horizontal lines to form a perceived array of writing boxes on the writing paper sheet; and
providing instruction to cursively writing on at least a portion of the writing paper sheet such that each box of the array of boxes contains substantially only one letter.

11. The method of claim 10, wherein the diagonal lines of the writing guide are equally spaced thereacross.

12. The method of claim 10, wherein the diagonal lines are continuous across the writing guide.

13. The method of claim 10, wherein the writing guide is positioned beneath a sheet of horizontally-lined writing paper such that at least one edge of the writing guide is aligned with at least one edge of the writing paper sheet.

14. A handwriting tool configured to instruct a person on how to write print letters, comprising:
a writing medium having a base color;
a first rectangular region of a first color extending across the writing medium, the first rectangular region having a bottom edge; and
a second rectangular region of a second color extending across the writing medium below the first rectangular region, the second color being distinct from the first color, and the second rectangular region having,
a top edge coterminous with the first rectangular region bottom edge, and
a bottom edge.

15. The tool of claim 14, further comprising a horizontal line extending across the writing medium along the second rectangular region bottom edge.

16. The tool of claim 14, wherein the second color is the base color.

17. The tool of claim 16, wherein the base color is white.

18. The tool of claim 14, wherein the first color is yellow.

19. A handwriting tool configured to instruct a person on how to write print letters, comprising:
a writing medium having a base color;
a horizontal line extending across the writing medium;
a first rectangular region of a first color extending across the writing medium, the first rectangular region having a top edge coterminous with the horizontal line and a bottom edge; and
a second rectangular region of a second color extending across the writing medium below the first rectangular region, the second color being distinct from the first color, and the second rectangular region having a top edge coterminous with the first rectangular region bottom edge.

20. The tool of claim 19, wherein the first color is the base color.

21. The tool of claim 19, wherein the second color is yellow.

22. A handwriting tool configured to instruct a person on how to write print letters, comprising:
a writing medium having a base color;
a first rectangular region of a first color extending across the writing medium and having a top edge and a bottom edge; and
a second rectangular region of a second color extending across the writing medium below the first rectangular region, the second color being distinct from the first color, and the second rectangular region having,
a top edge coterminous with the first rectangular region bottom edge, and
a bottom edge;
wherein the first rectangular region and second rectangular region together comprise a writing segment, the top edge of the first rectangular region forming a writing segment top edge and the bottom edge of the second rectangular region forming a writing segment bottom edge; and
wherein the writing medium has a plurality of writing segments formed thereon and arranged such that the top edge of one of the plurality of writing segments is coterminous with the bottom edge of another of the plurality of writing segments.
